(19) United States
(12) Patent Application Publication
(10) Pub. No.: US 2009/0108688 A1
(43) Pub. Date: Apr. 30, 2009

(54) CONNECTING STRUCTURE FOR CONNECTING ELECTRICAL APPARATUS AND FEEDER TERMINAL PORTION, AND VEHICLE

(75) Inventor: Tetsuya Miura, Aichi-ken (JP)

Correspondence Address: SUGHRUE MION, PLLC, 2100 PENNSYLVANIA AVENUE, N.W., SUITE 800, WASHINGTON, DC, 20037, US

(73) Assignee: TOYOTA JIDOSHA KABUSHIKI KAISHA, TOYOTA-SHI AICHI-KEN (JP)

(21) Appl. No.: 12/300,931

(22) PCT Filed: May 14, 2007
(86) PCT No.: PCT/JP2007/060295

§ 371 Date: Nov. 14, 2008

(30) Foreign Application Priority Data
May 17, 2006 (JP) 2006-137911

(51) Int. Cl. H02K 3/50

(52) U.S. Cl. 310/71

(57) ABSTRACT

A bus bar (263) identified as a led-out conductor portion led out from a coil end (262) of a motor generator identified as an electrical apparatus, and a feeding terminal block (220) disposed at a spacing from the bus bar (263) and having a cable (3A) connected thereto, are connected by a connecting member (4). The connecting member (4) has a bent shape as a whole, and includes a misalignment absorbing portion (46) which is provided by bending a part of the connecting member (4) and is deformable to absorb misalignment between the bus bar (263) and the feeding terminal block (220).

### TECHNICAL FIELD

The present invention relates to a connecting structure for connecting an electrical apparatus and a feeder terminal portion, and a vehicle, and particularly relates to a connecting structure between a led-out conductor portion led out from an electrical apparatus and a feeder terminal portion, and a vehicle equipped with the connecting structure.

### BACKGROUND ART

There are various types of electrical apparatuses, and a motor is widely known as one example thereof. Motors are used for infinitely various purposes, and used in various apparatuses such as an industrial apparatus, various types of vehicles, an air-conditioning apparatus, and an environmental protection apparatus.

The above-described vehicles include a hybrid vehicle and an electric vehicle, and a motor is also mounted on the hybrid vehicle and others. For example, if a motor is mounted on a hybrid vehicle, it is accommodated in an enclosure, and its coil winding is often led out to an outside of the enclosure that accommodates the motor. A led-out conductor portion of the coil winding is varnished, and a crimping terminal is crimped onto a tip portion of the led-out conductor portion. On the other hand, there is provided a terminal block to which a wire for feeding the motor is connected. It is possible to feed the motor by electrically connecting the terminal block and the crimping terminal.

An example of a structure of the above-described terminal block is described in, for example, Japanese Patent Laying-Open No. 2004-327184 and Japanese Patent Laying-Open No. 2004-327185. An example of a connecting structure between a led-out conductor portion of the above-described coil winding and a terminal block is described in, for example, Japanese Patent Laying-Open No. 2005-229753, Japanese Patent Laying-Open No. 2005-229754, and Japanese Patent Laying-Open No. 2005-229755.

In a motor module described in Japanese Patent Laying-Open No. 2005-229753 described above, a motor winding 116 and a terminal block 120 are connected via a flexible member 140. With the use of flexible member 140, component tolerances can be absorbed to a certain degree owing to deformation of flexible member 140. However, if an amount of misalignment between the led-out portion of motor winding 116 and terminal block 120 and its variations are increased, there arises a problem of difficulty in attachment work for flexible member 140.

In a motor module described in Japanese Patent Laying-Open No. 2005-229754, motor winding 116 and terminal block 120 are connected via a wire-connecting member 130. In this case as well, component tolerances can be absorbed to a certain degree. However, wire-connecting member 130 has a complicated structure that includes a fixed terminal 132 and a movable terminal 135, and hence a structure of the connecting portion between motor winding 116 and terminal block 120 becomes complicated, resulting in a problem of manufacturing cost increase.

In a motor module described in Japanese Patent Laying-Open No. 2005-229755, motor winding 116 and terminal block 120 are connected via a flexible member such as a flexible bus bar 140 or a plate-like conductor 140# having a spring-like portion 141. In this example as well, component tolerances can be absorbed to a certain degree owing to deformation of the flexible member. However, if an amount of misalignment between the led-out portion of motor winding 116 and terminal block 120 and its variations are increased, attachment work for the flexible member becomes difficult. Further, if the above-described flexible bus bar 140 is provided at the led-out portion of motor winding 116, a problem of manufacturing cost increase may also arise. Moreover, if spring-like conductor 140# having spring-like portion 141 is used as the flexible member, there may also arise a problem of increase in complexity of a structure of the flexible member.

As described above, in a connecting structure for connecting a motor winding and a terminal block in the conventional motor module mounted on a vehicle, if an amount of misalignment between the led-out portion of the motor winding and the terminal block and its variations are increased, there may arise a problem of difficulty in attachment work, a problem of increase in complexity of a structure of the connecting portion, and a problem of manufacturing cost increase. These problems may also arise in a connecting structure that connects a led-out conductor portion of an electrical apparatus other than the motor described in each of the above-described documents, and a feeder terminal portion.

### DISCLOSURE OF THE INVENTION

An object of the present invention is to provide a connecting structure for connecting an electrical apparatus and a feeder terminal portion, which can facilitate connecting work, simplify a structure of a connecting portion as well, and furthermore, suppress manufacturing cost increase, even if an amount of misalignment between a led-out conductor portion of the electrical apparatus and the feeder terminal portion and its variations are increased, and a vehicle equipped with the connecting structure.

A connecting structure for connecting an electrical apparatus and a feeder terminal portion according to the present invention includes: a led-out conductor portion led out from the electrical apparatus; a feeder terminal portion disposed at a spacing from the led-out conductor portion and having a feeder wire connected thereto; and a connecting member connecting the led-out conductor portion and the feeder terminal portion. The connecting member includes a first bent (curved) portion allowing the connecting member to have a bent shape as a whole, and a misalignment absorbing portion which is provided by bending a part of the connecting member, includes a plurality of second bent (curved) portions, and is deformable to absorb misalignment between the led-out conductor portion and the feeder terminal portion. Here, the bent (curved) portion in the specification of the present application refers to a bent (curved) site, and in the case of a U-shape misalignment absorbing portion, for example, the misalignment absorbing portion has four bent portions.

The electrical apparatus is, for example, a rotating electrical machine. A coating layer may be formed at a surface of the led-out conductor portion to improve stiffness of the led-out conductor portion. The feeder terminal portion may be a feeding terminal block.

The connecting member may further have a fixed portion fixed to the feeder terminal portion and a crimping terminal portion crimped onto the led-out conductor portion. In this case, the fixed portion is provided on one end side of the connecting member, the crimping terminal portion is provided on the other end side of the connecting member, the first bent portion is provided between the fixed portion and the crimping terminal portion, and the misalignment absorbing portion is provided between the first bent portion and the crimping terminal portion. However, the misalignment absorbing portion may also be provided between the first bent portion and the fixed portion.

A portion of the connecting member on the other end side may extend in a direction crossing a portion of the connecting member on the one end side, which portion of the connecting member on the one end side includes the fixed portion. Further, the fixed portion may be fixed to the feeder terminal portion with a fixing member, and may have a slotted hole for receiving the fixing member. In this case, a longitudinal direction of the slotted hole is preferably a direction identical to a direction in which the portion of the connecting member on the one end side extends.

The misalignment absorbing portion may also be provided at the connecting member in a convex manner by bending and deforming the connecting member at a plurality of sites.

A portion of the connecting member on the other end side may also extend along the led-out conductor portion. In this case, the misalignment absorbing portion may be provided at the connecting member such that the misalignment absorbing portion protrudes in a direction crossing the direction in which the led-out conductor portion is led out, or protrudes in the direction in which the led-out conductor portion is led out. Further, a portion of the connecting member on the other end side may also extend in a direction crossing a direction in which the led-out conductor portion is led out. In this case, the misalignment absorbing portion may also be provided at the connecting member such that the misalignment absorbing portion protrudes in a direction crossing the direction in which the led-out conductor portion is led out, or protrudes in the direction in which the led-out conductor portion is led out.

The connecting member may be configured with a single-piece plate-like metal member. Further, the misalignment absorbing portion may also have an approximately U-shape.

If the connecting member further has a fixed portion fixed to the feeder terminal portion and a crimping terminal portion crimped onto the led-out conductor portion, an intermediate portion of the connecting member, positioned between the first bent portion and one of the crimping terminal portion and the fixed portion, may also be configured with a combination of a plurality of circular arc-shaped portions each conforming to a circular arc having a radius R, and a length L of the intermediate portion may also be set to satisfy a relation of R=L/5.

If the misalignment absorbing portion is provided by bending and deforming the connecting member at a plurality of sites, a thickness of the second bent portions and their vicinity of the misalignment absorbing portion may also be made larger than a thickness of a portion of the misalignment absorbing portion other than the second bent portions and their vicinity.

It is noted that at least two configurations in the above-described configurations may also be combined as appropriate.

A vehicle according to the present invention includes the above-described connecting structure for connecting the electrical apparatus and the feeder terminal portion.

In the connecting structure for connecting the electrical apparatus and the feeder terminal portion in the present invention, the connecting member has the misalignment absorbing portion, and hence even if an amount of relative misalignment between the led-out conductor portion of the electrical apparatus and the feeder terminal portion and its variations are large, the misalignment absorbing portion can preferentially be deformed to absorb the amount of misalignment between the led-out conductor portion of the electrical apparatus and the feeder terminal portion, to thereby facilitate attachment work for the connecting member. Further, it is possible to provide the misalignment absorbing portion only by shaping a part of the connecting member in a bent manner, so that a structure of the connecting member may also be simplified. As a result, it becomes possible to simplify a structure of the connecting portion for connecting the led-out conductor portion of the electrical apparatus and the feeder terminal portion, and even suppress manufacturing cost increase.

### BRIEF DESCRIPTION OF THE DRAWINGS

FIG. 1 is a schematic view that shows an example of a configuration of a hybrid vehicle on which a connecting structure for connecting an electrical apparatus and a feeder terminal portion in each embodiment of the present invention can be mounted.

FIG. 2 is a drawing that shows a schematic configuration of a motor generator and its vicinity shown in FIG. 1.

FIG. 3 is a side view that shows a connecting structure for connecting a bus bar of a motor generator and a feeding terminal block in a first embodiment of the present invention.

FIG. 4 is a front view of a connecting member in the first embodiment of the present invention.

FIG. 5 is a plan view that shows an example of a shape of a plate-like member with which the connecting member in the first embodiment of the present invention can be fabricated.

FIG. 6 is a side view that shows a connecting structure for connecting a bus bar of a motor generator and a feeding terminal block in a second embodiment of the present invention.

FIG. 7 is a drawing that shows a modification of the connecting member in the second embodiment of the present invention.

FIG. 8 is a drawing that shows another modification of the connecting member in the second embodiment of the present invention.

FIG. 9 is a side view that shows a connecting structure for connecting a bus bar of a motor generator and a feeding terminal block in a third embodiment of the present invention.

FIG. 10 is a side view that shows a connecting structure for connecting a bus bar of a motor generator and a feeding terminal block in a fourth embodiment of the present invention.

FIG. 11 is a side view that shows a connecting structure for connecting a bus bar of a motor generator and a feeding terminal block in a fifth embodiment of the present invention.

FIG. 12 is a side view that shows a connecting structure for connecting a bus bar of a motor generator and a feeding terminal block in a sixth embodiment of the present invention.

FIG. 13 is a side view that shows a connecting structure for connecting a bus bar of a motor generator and a feeding terminal block in a seventh embodiment of the present invention.

FIG. 14 is a side view that shows a connecting structure for connecting a bus bar of a motor generator and a feeding terminal block in a modification of the seventh embodiment of the present invention.

FIG. 15 is a side view that shows a connecting structure for connecting a bus bar of a motor generator and a feeding terminal block in another modification of the seventh embodiment of the present invention.

### BEST MODES FOR CARRYING OUT THE INVENTION

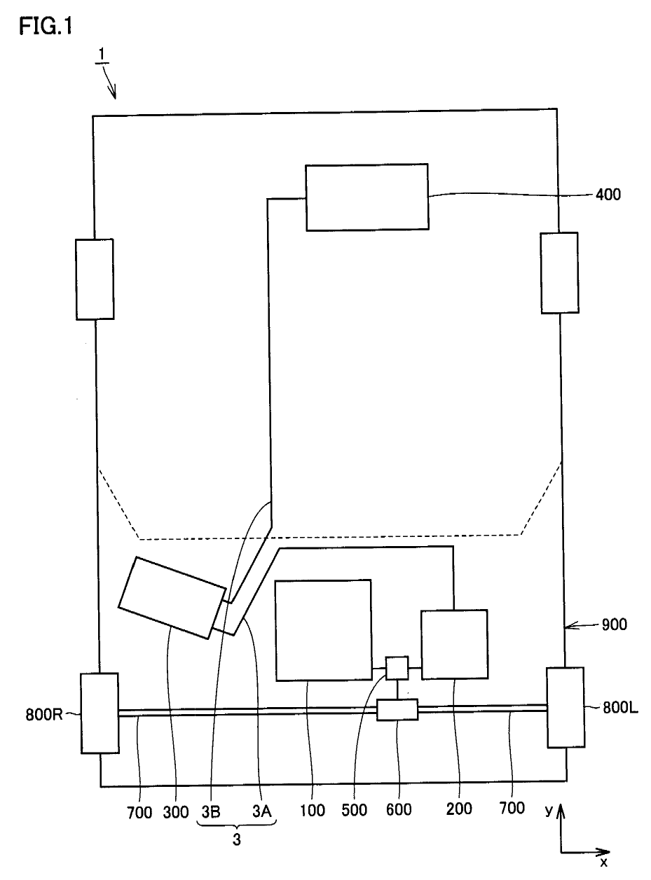

Embodiments of the present invention will hereinafter be described with the use of FIG. 1 to FIG. 15. As to the embodiments described below, an example in which the present invention is applied to a connecting portion for connecting a motor generator (rotating electrical machine) and a terminal block (feeding terminal block) mounted on a hybrid vehicle will be described with the use of the drawings. However, it is noted that the present invention may also be applied to a connecting portion for connecting a led-out conductor portion of an electrical apparatus other than the motor generator and a feeder terminal portion other than the feeding terminal block. Further, the present invention may also be applied to an electrical apparatus mounted on various types of vehicles (e.g. a fuel-cell vehicle and an electric-powered vehicle that includes an electric vehicle) other than the hybrid vehicle, and various apparatuses such as an industrial apparatus, an air-conditioning apparatus, and an environmental protection apparatus.

In the embodiments below, the same or corresponding portions are provided with the same reference characters. Further, not all components in each embodiment are essential, and it is also expected from the beginning that some of the components can be omitted.

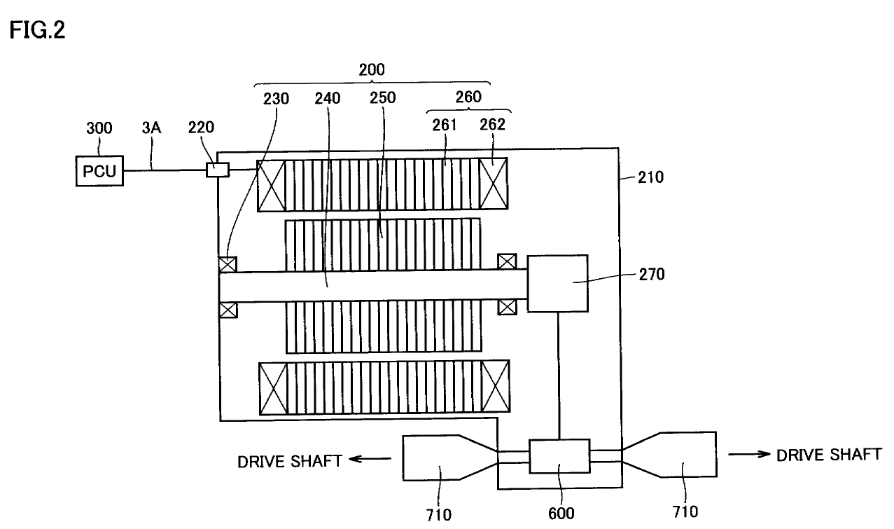

Here, with the use of FIG. 1 and FIG. 2, there will be described an example of a configuration of a hybrid vehicle 1 on which a connecting structure for connecting an electrical apparatus and a feeder terminal portion, described in each embodiment below, can be mounted. FIG. 1 is a schematic view that shows an example of a configuration of a hybrid vehicle on which a connecting structure for connecting an electrical apparatus and a feeder terminal portion in each embodiment below can be mounted. FIG. 2 is a drawing that shows a schematic configuration of a motor generator and its vicinity shown in FIG. 1.

Hybrid vehicle 1 shown in FIG. 1 is an FF (Front engine Front wheel drive) layout vehicle. However, it is noted that the connecting structure for connecting an electrical apparatus and a feeder terminal portion in each embodiment below can also be applied to an FR (Front engine Rear wheel drive) layout hybrid vehicle, as well as the FF layout hybrid vehicle. In general, a configuration of an FR layout vehicle slightly differs from a configuration of an FF layout vehicle with regard to an arrangement of an engine and others, and a feature that mechanical power is transmitted from an engine located frontward to rear wheels via a propeller shaft. However, other basic configurations are similar, and a configuration of the FR layout hybrid vehicle is also well known, and hence the description about the FR layout hybrid vehicle will not be repeated in the specification of the present application.

As shown in FIG. 1, hybrid vehicle 1 includes an engine 100, a motor generator 200, a PCU (Power Control Unit) 300, a battery 400, a power split device 500, a differential mechanism 600, a drive shaft 700, and drive wheels 800L, 800R identified as front wheels.

In the example in FIG. 1, engine 100, motor generator 200, PCU 300, and power split device 500 are disposed in an engine room 900. PCU 300 is provided at a vehicle side portion between a cowl and a suspension for the front wheels. Motor generator 200 and PCU 300 are connected via a cable 3A. PCU 300 and battery 400 are connected via a cable 3B. Further, a mechanical power output device formed of engine 100 and motor generator 200 is coupled to differential mechanism 600 via power split device 500. Differential mechanism 600 is coupled to drive wheels 800L, 800R via drive shaft 700.

Motor generator 200 is a three-phase alternating current synchronous motor generator, and generates driving force by alternating-current electric power received from PCU 300. Further, motor generator 200 is also used as power generator during deceleration or the like of hybrid vehicle 1, and generates alternating-current electric power by the action of generating power (regenerative power generation), and outputs the generated alternating-current electric power to PCU 300.

PCU 300 converts a direct-current voltage received from battery 400 into an alternating-current voltage to drive and control motor generator 200. PCU 300 converts an alternating-current voltage generated by motor generator 200 into a direct-current voltage to charge battery 400. Power split device 500 is configured with a combination of various types of elements such as a planetary gear (not shown).

The mechanical power output from engine 100 and/or motor generator 200 is transmitted from power split device 500 to drive shaft 700 via differential mechanism 600. The driving force transmitted to drive shaft 700 is transmitted as torque to drive wheels 800L, 800R, so that the vehicle can run thereby. In this case, motor generator 200 operates as an electric motor.

On the other hand, during deceleration or the like of the vehicle, motor generator 200 is driven by drive wheels 800L, 800R or engine 100. In this case, motor generator 200 operates as a power generator. Electric power generated by motor generator 200 is stored in battery 400 via an inverter in PCU 300.

Next, with the use of FIG. 2, a configuration of motor generator 200 and its vicinity will be described in somewhat more detail.

As described above, motor generator 200 is a rotating electrical machine that has a function of an electric motor or a power generator, and has a rotary shaft 240 rotatably attached to a housing 210 via a bearing 230, a rotor 250 attached to rotary shaft 240, and a stator 260.

Stator 260 has a stator core 261, and a coil is wound around stator core 261. An end portion of the wound coil, namely, a coil end 262 is electrically connected to a feeding terminal block 220 provided at housing 210, via a bus bar (led-out conductor portion) 263. Feeding terminal block 220 is electrically connected to PCU 300 via feeder cable 3A. As shown in FIG. 1, PCU 300 is electrically connected to battery 400 via feeder cable 3B, and hence battery 400 and coil 262 are electrically connected via PCU 300 and feeder cables 3A, 3B.

As shown in FIG. 2, motor generator 200 described above is connected to differential mechanism 600 via a reduction gear mechanism 270, and differential mechanism 600 is connected to drive shaft 700 via a drive shaft receiving portion 710. Accordingly, mechanical power output from motor generator 200 is transmitted to drive shaft 700 via reduction gear mechanism 270, differential mechanism 600, and drive shaft receiving portion 710.

### FIRST EMBODIMENT

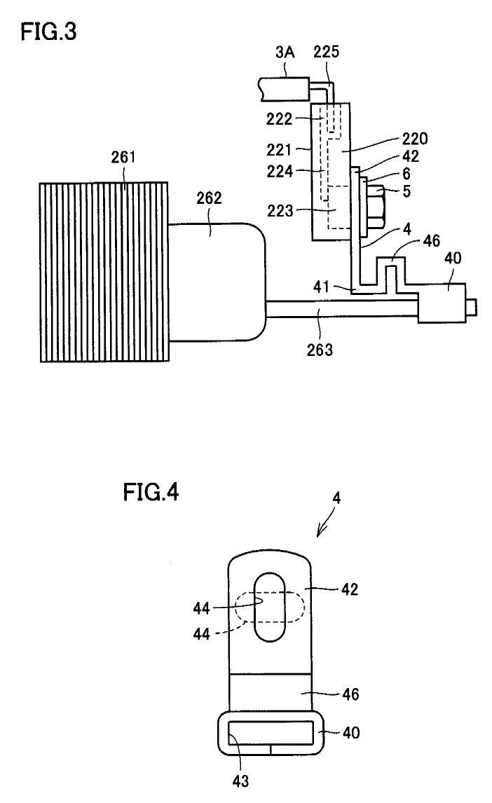

Next, a first embodiment of the present invention will be described with the use of FIG. 3 to FIG. 5. FIG. 3 is a drawing that shows a connecting structure for connecting bus bar (led-out conductor portion) 263 of the motor generator and feeding terminal block 220 serving as the feeder terminal portion, in the first embodiment. The connecting structure shown in FIG. 3 is identified as a structure useful for an FR layout hybrid vehicle.

As shown in FIG. 3, bus bar 263 led out from coil end 262 of stator core 261 extends in an axial direction of the stator of the motor generator. In the first embodiment, a surface of bus bar 263 is varnished to improve stiffness of bus bar 263. It is noted that processing other than varnishing may be applied to form a coating layer that improves stiffness of bus bar 263.

As shown in FIG. 1 and FIG. 2, for example, feeding terminal block 220 is electrically connected to electrical power supply sources such as PCU 300 and battery 400 via feeder wires such as cables 3 (3A, 3B). As shown in FIG. 3, for example, feeding terminal block 220 has an enclosure 221, a first connected portion 222 provided at enclosure 221 and electrically connected to an end portion (connected end) 225 of cable (feeder wire) 3A, an internal conductor 224 configured with a conductive member such as a metal-made member and provided in enclosure 221, and a second connected portion 223 provided at enclosure 221 and electrically connected to a connecting member 4 described below. Each of first and second connected portions 222, 223 includes a conductive member such as a metal-made member, and is electrically connected to the internal conductor. It is thereby possible to electrically connect cable 3A and connecting member 4 via feeding terminal block 220.

In the example in FIG. 3, feeding terminal block 220 is arranged at a position in the vicinity of bus bar 263, and adjacent to coil end 262 of stator core 261 in the axial direction of the motor generator (the direction in which the bas bar is led out). More specifically, feeding terminal block 220 is arranged in a space on the periphery of bus bar 263, in the vicinity of coil end 262, at a spacing from bus bar 263 and coil end 262.

In the case of an FR layout vehicle, a motor generator is often provided below a boarding space. To ensure the largest possible boarding space, it is not preferable that a space for accommodating the motor generator is enlarged in a radial direction of the motor generator. Therefore, as described above, feeding terminal block 220 is arranged at the position adjacent to coil end 262 in the axial direction of the motor generator. This eliminates the need to enlarge the space for accommodating the motor generator in the radial direction of the motor generator, so as to dispose feeding terminal block 220 and elements connected thereto. Accordingly, as previously described, it can be said that the connecting structure in the present embodiment is identified as a structure useful for an FR layout hybrid vehicle.

Between feeding terminal block 220 and bus bar 263 described above, connecting member 4 for electrically and mechanically connecting them is disposed. Connecting member 4 has a bent shape (e.g. an approximately L-shape) as a whole, and as shown in FIG. 3 and FIG. 4, includes a crimping terminal portion 40 having a through hole 43 and crimped onto bus bar 263, a bent portion (first bent portion) 41, a fixed portion 42 fixed to feeding terminal block 220 and having a slotted hole 44, and a misalignment absorbing portion 46.

Connecting member 4 described above can be fabricated of a conductive flexible member. For example, by deforming a plate-like member made of metal such as copper, it is possible to fabricate connecting member 4. When a plate-like member is used to fabricate connecting member 4, a plate-like member 4a having a shape as shown in FIG. 5 may be stamped, for example, to be plastic-deformed. As such, since it is possible to fabricate connecting member 4 only by deforming a single-piece plate-like member, connecting member 4 can be fabricated with ease and at low cost.

It is noted that a plurality of members may also be combined to fabricate connecting member 4. Alternatively, a plate-like conductive member having a bent portion may be prepared in advance, and a part of the plate-like conductive member may be deformed to fabricate connecting member 4. For example, an L-shape plate-like conductive member may be prepared, and the plate-like conductive member may be deformed to form crimping terminal portion 40 and misalignment absorbing portion 46.

In the example in FIG. 5, plate-like member 4a has slotted hole 44 on one end side in a longitudinal direction, and a projecting portion 40a on the other end side in the longitudinal direction. Plate-like member 4a shown in FIG. 5 is bent and deformed, and projecting portion 40a are deformed in an annular manner such that opposite tip portions of projecting portion 40a are abutted against each other or overlaid on each other. It is thereby possible to fabricate connecting member 4 having the shape as shown in FIG. 3 and FIG. 4.

As shown in FIG. 3, fixed portion 42 of connecting member 4 is provided on one end side of connecting member 4 in its longitudinal (extending) direction, and fixed to feeding terminal block 220 with a fixing member such as a bolt 5. In the example in FIG. 3, an underlying member such as a washer 6 is disposed between a head portion of bolt 5 and fixed portion 42. By disposing an underlying member as such, bolt 5 can be prevented from being loosened.

Fixed portion 42 is typically configured with a flat plate-like portion of connecting member 4. On the other hand, a surface of feeding terminal block 220 against which fixed portion 42 is abutted is also configured with a flat surface. By doing so, connecting member 4 can easily and firmly be fixed to feeding terminal block 220. Here, as shown in FIG. 3, by allowing the underlying member such as washer 6 to have a larger size such that it projects outward from the head portion of bolt 5, it is possible to more firmly fix fixed portion 42 to feeding terminal block 220, and prevent bolt 5 from being loosened after fixation.

A shaft portion of bolt 5 shown in FIG. 3 is inserted into slotted hole 44. As shown in FIG. 4, the longitudinal direction of slotted hole 44 is preferably a direction identical to the extending (longitudinal) direction of the portion of connecting member 4 on the one end side. It is thereby possible to displace connecting member 4 in a direction crossing the axial direction of the motor generator (e.g. a direction pointing from feeding terminal block 220 to bus bar 263) when connecting member 4 is attached. Even if bus bar 263 is misaligned in a direction crossing the axial direction of the motor generator, the misalignment can be absorbed.

It is noted that if slotted hole 44 is provided, the longitudinal direction of slotted hole 44 may also correspond with an arbitrary direction other than the above-described direction. For example, as shown in FIG. 4 by a dotted line, for example, slotted hole 44 may also be formed such that its longitudinal direction corresponds with a width direction orthogonal to the extending direction of the portion of connecting member 4 on the one end side, or such that its longitudinal direction corresponds with a direction crossing the extending direction of the portion of connecting member 4 on the one end side. Stated differently, a length, a width, a direction, and others of slotted hole 44 may be selected as appropriate in accordance with an amount of misalignment of bus bar 263 in a direction away from feeding terminal block 220 and/or a direction of misalignment.

Crimping terminal portion 40 is provided on the other end side of connecting member 4 in the longitudinal direction. Crimping terminal portion 40 typically has an annular shape. However, an arbitrary shape may be adopted as long as crimping terminal portion 40 can be crimped onto and connected to the tip portion of bus bar 263. When crimping terminal portion 40 and bus bar 263 are to be connected, crimping terminal portion 40 may be squeezed and deformed while the tip portion of bus bar 263 is received in through hole 43 of crimping terminal portion 40 shaped in an annular manner. By doing so, it is possible to crimp crimping terminal portion 40 onto the tip portion of bus bar 263, and electrically and mechanically connect crimping terminal portion 40 and bus bar 263.

Bent portion 41 (first bent portion) is a bent portion that has a function of allowing connecting member 4 to have a bent shape as a whole, and is provided between fixed portion 42 and crimping terminal portion 40 as shown in FIG. 3. The number of bent portions 41 may be set arbitrarily. In the example in FIG. 3, one bent portion 41 is provided at an approximately central portion of connecting member 4 in the longitudinal direction.

Further, in the example in FIG. 3, the portion of connecting member 4 on the one end side, where fixed portion 42 is provided, and the portion of connecting member 4 on the other end side, where crimping terminal portion 40 is provided, extend in directions approximately orthogonal to each other. However, an angle formed by the portion of connecting member 4 on the one end side and the portion of connecting member 4 on the other end side may also be an acute angle or an obtuse angle, and may be set arbitrarily, as long as both of them extend in directions crossing each other.

Misalignment absorbing portion 46 can be provided only by bending and deforming a part of connecting member 4, for example, and is deformable to absorb misalignment between bus bar 263 and feeding terminal block 220. By providing misalignment absorbing portion 46 at connecting member 4 as such, even if an amount of relative misalignment between bus bar 263 and feeding terminal block 220 and its variations are large, misalignment absorbing portion 46 can preferentially be deformed to absorb misalignment between bus bar 263 and feeding terminal block 220, to thereby facilitate attachment work for connecting member 4. Further, it is possible to provide misalignment absorbing portion 46 only by deforming, for example, a part of connecting member 4 in a bent manner, so that a structure of connecting member 4 can also be simplified. Consequently, it is possible to simplify a structure of the connecting portion for connecting bus bar 263 and feeding terminal block 220 and even suppress manufacturing cost increase.

Misalignment absorbing portion 46 is provided at a position away from bent portion 41. As shown in FIG. 3, for example, it may be provided between bent portion 41 and crimping terminal portion 40, or may also be provided between bent portion 41 and fixed portion 42. By providing misalignment absorbing portion 46 at a position away from bent portion 41, an amount of misalignment in a desired direction can effectively be absorbed by misalignment absorbing portion 46, while an amount of deformation of connecting member 4 at bent portion 41 is kept small. Further, misalignment absorbing portion 46 has a plurality of bent portions (second bent portions). In the example in FIG. 3, misalignment absorbing portion 46 is provided at connecting member 4 in a convex manner by, for example, bending and deforming connecting member 4 at a plurality of sites. More specifically, misalignment absorbing portion 46 is defined by a pair of upward-extending portions extending in a direction away from bus bar 263 and having an approximately U-shape, and a coupling portion that couples the upward-extending portions.

In the example in FIG. 3, the portion of connecting member 4 on the other end side (the portion on the side of crimping terminal portion 40) extends along bus bar 263 in the axial direction of the motor generator, resulting in that misalignment absorbing portion 46 protrudes in a direction approximately orthogonal to the axial direction of the motor generator (the longitudinal direction of bus bar 263). Stated differently, the pair of upward-extending portions of misalignment absorbing portion 46 extends in the direction approximately orthogonal to the axial direction of the motor generator, and the coupling portion of misalignment absorbing portion 46 extends in the axial direction of the motor generator.

The portion of connecting member 4 on the other end side, which includes misalignment absorbing portion 46, can be deformed in the axial direction of the motor generator as well as a direction orthogonal to the axial direction. In the example in FIG. 3, an amount of deformation of connecting member 4 in the axial direction of the motor generator can be made larger than an amount of deformation of connecting member 4 in a direction orthogonal to the axial direction. Therefore, connecting member 4 shown in FIG. 3 becomes effective at absorbing misalignment in the axial direction of the motor generator. On the other hand, slotted hole 44 provided in fixed portion 42 can be utilized to absorb misalignment of bus bar 263 in a direction orthogonal to (crossing) the axial direction of the motor generator.

Accordingly, by adopting connecting member 4 in the first embodiment, misalignment of bus bar 263 in the axial direction of the motor generator as well as a direction orthogonal to (crossing) the axial direction can be absorbed with ease.

It is noted that although in the example in FIG. 3, misalignment absorbing portion 46 is provided such that it protrudes only on one surface side of connecting member 4 (e.g. on the upper surface side in the example in FIG. 3), misalignment absorbing portions 46 may also be provided such that they protrude from the opposite surfaces of connecting member 4 (the upper and lower surfaces in FIG. 3) in upward and downward directions, respectively.

### SECOND EMBODIMENT

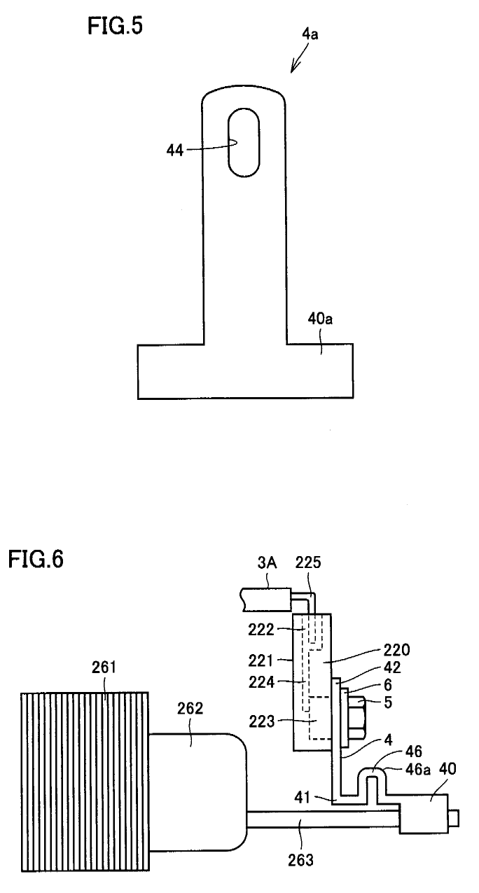

Next, with the use of FIG. 6 to FIG. 8, a second embodiment of the present invention and its modifications will be described. FIG. 6 is a drawing that shows a connecting structure for connecting bus bar 263 of the motor generator and feeding terminal block 220 in the second embodiment. The connecting structure in the second embodiment is also identified as a structure useful for an FR layout hybrid vehicle.

As shown in FIG. 6, in the second embodiment, a corner portion of misalignment absorbing portion 46 is rounded. By rounding the corner portion of misalignment absorbing portion 46 as such, it is possible to relieve stress concentration at the corner portion when misalignment absorbing portion 46 is deformed. Other configurations are basically similar to those of the first embodiment. Therefore, effects similar to those of the first embodiment can also be expected.

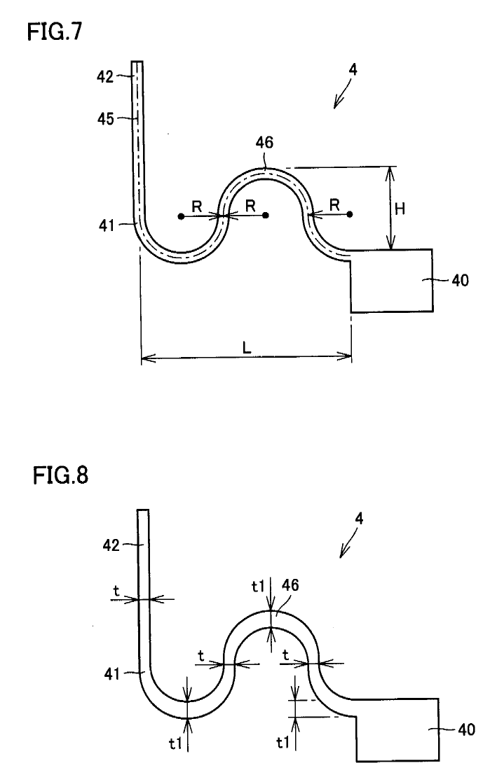

Next, with the use of FIG. 7 and FIG. 8, modifications of the second embodiment will be described. As shown in FIG. 7 and FIG. 8, an intermediate portion of connecting member 4, positioned between bent portion 41 and crimping terminal portion 40, may be configured with a curved portion. By doing so, it is possible to further relieve stress concentration at misalignment absorbing portion 46 and its vicinity when misalignment absorbing portion 46 is deformed along with connecting member 4.

In the example in FIG. 7, the intermediate portion of connecting member 4, positioned between bent portion 41 and crimping terminal portion 40, is configured with a combination of a plurality of circular arc-shaped portions. Circular arcs defined by a center line 45 in a width direction of the circular arc-shaped portions are caused to have equal radii R. Further, a length L of the above-described intermediate portion of connecting member 4 is set to satisfy the relation of R=L/5. A larger protruding height H of misalignment absorbing portion 46 with respect to connecting member 4 is preferable, and hence, to increase protruding height H, a length of the pair of upward-extending portions in misalignment absorbing portion 46 may also be increased.

In the example in FIG. 8, a thickness t of connecting member 4 is varied. More specifically, a thickness t1 of the bent portions and their vicinity of connecting member 4 is made larger than thickness t of a portion other than the bent portions and their vicinity. In misalignment absorbing portion 46, thickness t1 of the bent portions (second bent portions) and their vicinity of misalignment absorbing portion 46 is made larger than thickness t of a portion of misalignment absorbing portion 46 other than the bent portions and their vicinity. In this case, it is possible to increase strength of the bent portions and their vicinity of connecting member 4.

### THIRD EMBODIMENT

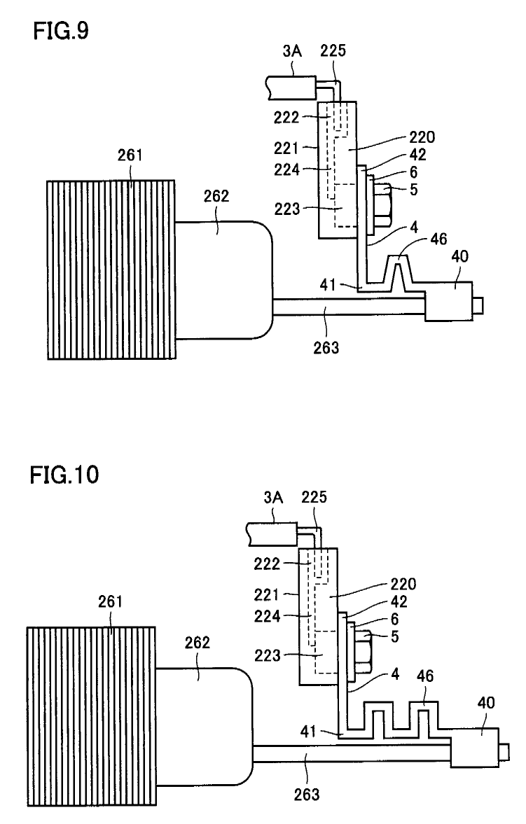

Next, with the use of FIG. 9, a third embodiment of the present invention will be described. FIG. 9 is a drawing that shows a connecting structure for connecting bus bar 263 of the motor generator and feeding terminal block 220 in the third embodiment. The connecting structure in the third embodiment is also identified as a structure useful for an FR layout hybrid vehicle.

In each of the embodiments described above, misalignment absorbing portion 46 has an approximately U-shape. However, the shape of misalignment absorbing portion 46 can arbitrarily be selected. As shown in FIG. 9, for example, misalignment absorbing portion 46 may have an approximately V-shape. Other configurations are basically similar to those of the first embodiment. Therefore, in the third embodiment as well, effects similar to those of the first embodiment can be expected.

### FOURTH EMBODIMENT

Next, with the use of FIG. 10, a fourth embodiment of the present invention will be described. FIG. 10 is a drawing that shows a connecting structure for connecting bus bar 263 of the motor generator and feeding terminal block 220 in the fourth embodiment. The connecting structure in the fourth embodiment is also identified as a structure useful for an FR layout hybrid vehicle.

In each of the embodiments described above, there is shown the case where one misalignment absorbing portion 46 is provided. However, a plurality of misalignment absorbing portions 46 may also be provided. In the example in FIG. 10, for example, two misalignment absorbing portions 46 are provided. Other configurations are basically similar to those of the first embodiment.

If a plurality of misalignment absorbing portions 46 are provided as in the fourth embodiment, it is possible to produce the effects similar to those of the first embodiment, and in addition, even cope with the case where bus bar 263 is misaligned in the axial direction of the motor generator by an amount larger than an amount in each of the embodiments described above.

It is noted that if a plurality of misalignment absorbing portions 46 are provided, a spacing between misalignment absorbing portions 46 can arbitrarily be selected. If at least three misalignment absorbing portions 46 are provided, for example, misalignment absorbing portions 46 may be equally spaced apart or differently spaced apart. Further, as shown in FIG. 10, misalignment absorbing portions 46 may protrude from connecting member 4 in the same direction, or alternatively, misalignment absorbing portions 46 may protrude in different directions. Further, a plurality of misalignment absorbing portions 46 may be provided at the portion of connecting member 4 on one end side (the portion on the side of fixed portion 42). Alternatively, one or a plurality of misalignment absorbing portion(s) 46 may also be provided at both of the portion of connecting member 4 on one end side and the portion of connecting member 4 on the other end side (the portion on the side of crimping terminal portion 40).

### FIFTH EMBODIMENT

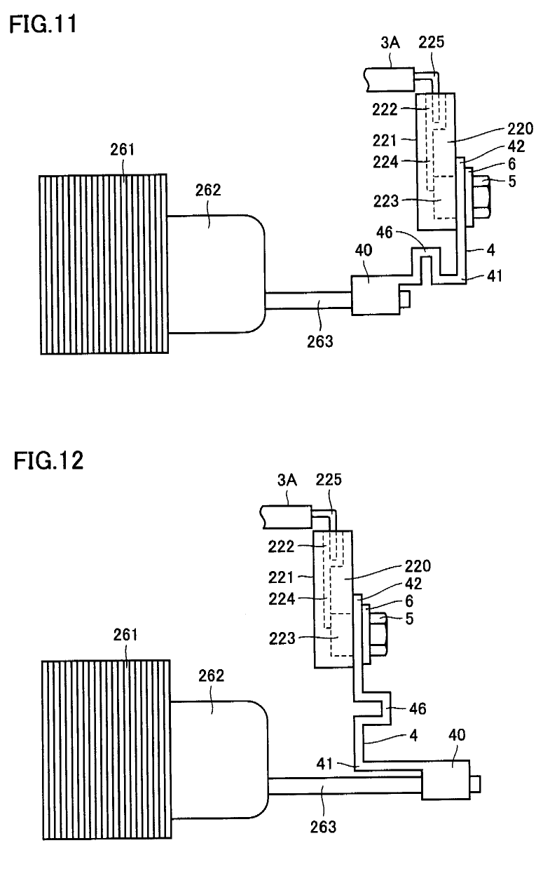

Next, with the use of FIG. 11, a fifth embodiment of the present invention will be described. FIG. 11 is a drawing that shows a connecting structure for connecting bus bar 263 of the motor generator and feeding terminal block 220 in the fifth embodiment. The connecting structure in the fifth embodiment is also identified as a structure useful for an FR layout hybrid vehicle.

In each of the embodiments described above, there is shown an example of the structure in which feeding terminal block 220 is arranged between the tip of bus bar 263 and coil end 262. However, the connecting structure in the present invention is also applicable to the case where feeding terminal block 220 is provided on a side opposite to coil end 262 with respect to the tip of bus bar 263.

As shown in FIG. 11, in the fifth embodiment, the portion of connecting member 4 on the other end side (the portion on the side of crimping terminal portion 40) is allowed to extend in the axial direction of the motor generator and in a direction away from the tip of bus bar 263. Misalignment absorbing portion 46 is provided between crimping terminal portion 40 and bent portion 41, and connecting member 4 is bent as a whole such that the portion of connecting member 4 on the one end side (the portion on the side of fixed portion 42) extends in a direction crossing (e.g. a direction orthogonal to) the portion of connecting member 4 on the other end side. Other configurations are basically similar to those of the first embodiment. Therefore, in the fifth embodiment as well, effects similar to those of the first embodiment can be expected.

### SIXTH EMBODIMENT

Next, with the use of FIG. 12, a sixth embodiment of the present invention will be described. FIG. 12 is a drawing that shows a connecting structure for connecting bus bar 263 of the motor generator and feeding terminal block 220 in the sixth embodiment. The connecting structure in the sixth embodiment is also identified as a structure useful for an FR layout hybrid vehicle.

In each of the embodiments described above, there is shown a case where misalignment absorbing portion 46 is provided at the portion of connecting member 4 on the other end side (the portion on the side of crimping terminal portion 40). However, misalignment absorbing portion 46 may be provided at the portion of connecting member 4 on the one end side (the portion on the side of fixed portion 42). In this case, misalignment absorbing portion 46 protrudes in the axial direction of the motor generator.

In the case of the sixth embodiment, it is possible to increase an amount of deformation of connecting member 4 in a direction crossing (e.g. a direction orthogonal to) the axial direction of the motor generator. Therefore, if an amount of misalignment of bus bar 263 in a direction crossing the axial direction of the motor generator becomes large, the connecting structure in the sixth embodiment is useful. Other configurations are basically similar to those of the first embodiment.

As described above, misalignment absorbing portion 46 can absorb misalignment of bus bar 263 in a direction crossing the axial direction of the motor generator, and hence if slotted hole 44 is provided in fixed portion 42, slotted hole 44 may be formed such that its longitudinal direction corresponds with a direction crossing the extending (longitudinal) direction of fixed portion 42 (an up-and-down direction in FIG. 4) (e.g. a width direction orthogonal to the above-described longitudinal direction: a left-and-right direction in FIG. 4), as shown by a dotted line in FIG. 4. Further, in some cases, a circular hole may also be provided in fixed portion 42 instead of slotted hole 44.

### SEVENTH EMBODIMENT

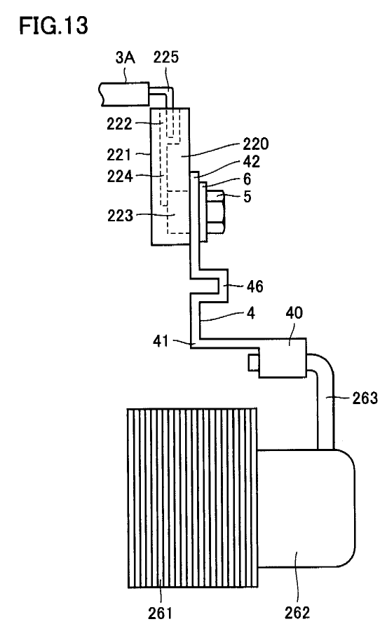

Next, with the use of FIG. 13 to FIG. 15, a seventh embodiment of the present invention and its modifications will be described. FIG. 13 is a drawing that shows a connecting structure for connecting bus bar 263 of the motor generator and feeding terminal block 220 in the seventh embodiment. The connecting structure in the seventh embodiment is identified as a structure useful for an FF layout hybrid vehicle.

In the case of an FF layout hybrid vehicle, motor generator 200 is generally disposed in engine room 900 as shown in FIG. 1. In this case, unlike the case of an FR layout, it is possible to ensure a space for arranging an element such as feeding terminal block 220 on the periphery of motor generator 200. Therefore, in the seventh embodiment, feeding terminal block 220 is provided in a space on the periphery of motor generator 200 as shown in FIG. 13.

In the example in FIG. 13, bus bar 263 is led out from an outer periphery of coil end 262 in a direction crossing the axial direction of the motor generator (a radial direction of stator core 261). Further, the tip portion of bus bar 263 is bent and then extends along the axial direction of the motor generator. Onto the tip portion of bus bar 263, crimping terminal portion 40 of connecting member 4 is crimped.

The portion of connecting member 4 on the one end side (the portion on the side of fixed portion 42) extends in a direction crossing (e.g. a direction orthogonal to) the axial direction of the motor generator, and the portion of connecting member 4 on the other end side (the portion on the side of crimping terminal portion 40) extends along the axial direction of the motor generator. Misalignment absorbing portion 46 is provided between bent portion 41 and fixed portion 42. In the example in FIG. 13, misalignment absorbing portion 46 protrudes in the axial direction of the motor generator (a direction crossing the direction in which bus bar 263 is led out). Other configurations are basically similar to those of each of the embodiments described above.

In the case of the seventh embodiment, misalignment absorbing portion 46 is provided at the portion of connecting member 4 on the one end side, which portion extends in a direction crossing the axial direction of the motor generator. It is therefore possible to increase an amount of deformation of connecting member 4 in a direction crossing the axial direction of the motor generator. Therefore, the seventh embodiment is useful if an amount of misalignment of bus bar 263 in a direction crossing the axial direction of the motor generator is large.

It is noted that if slotted hole 44 extending in the extending (longitudinal) direction of fixed portion 42 (an up-and-down direction in FIG. 13) is provided in fixed portion 42, it is possible to even cope with the case where an amount of misalignment of bus bar 263 in a direction crossing the axial direction of the motor generator becomes much larger.

Further, connecting member 4 in the seventh embodiment can also be deformed to a certain degree in the axial direction of the motor generator, and hence with deformation of connecting member 4, misalignment of bus bar 263 in the axial direction of the motor generator can also be absorbed to a certain degree.

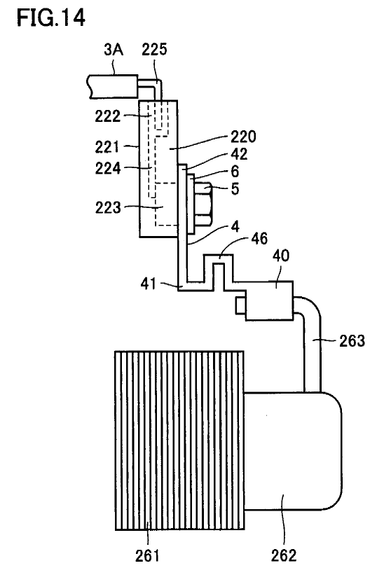

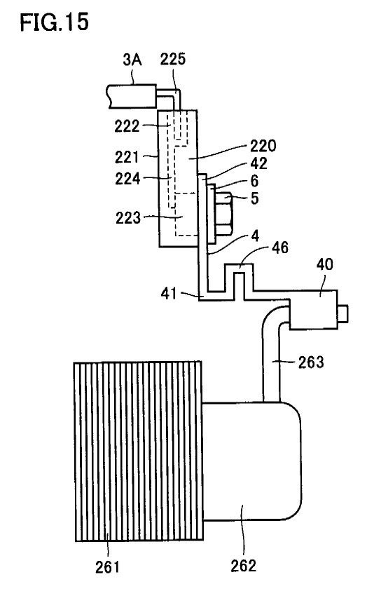

Next, with the use of FIG. 14 and FIG. 15, modifications of the connecting structure in the seventh embodiment will be described.

As shown in FIG. 14, misalignment absorbing portion 46 may also be provided between bent portion 41 and crimping terminal portion 40. In this case, misalignment absorbing portion 46 protrudes in a direction crossing the axial direction of the motor generator (the direction in which bus bar 263 is led out). Other configurations are basically similar to those shown in FIG. 13.

In the present modification, misalignment absorbing portion 46 is provided at the portion of connecting member 4 on the other end side, which portion extends in the axial direction of the motor generator, and hence an amount of deformation of connecting member 4 in the axial direction of the motor generator can be increased. Therefore, the present modification is useful if an amount of misalignment of bus bar 263 in the axial direction of the motor generator is large.

Further, if slotted hole 44 extending in the longitudinal direction of fixed portion 42 (the up-and-down direction in FIG. 14) is provided in fixed portion 42, slotted hole 44 can absorb misalignment of bus bar 263 in a direction crossing the axial direction of the motor generator. Further, connecting member 4 in the present modification can be deformed to a certain degree in a direction crossing the axial direction of the motor generator, and hence with deformation of connecting member 4, misalignment of bus bar 263 in a direction crossing the axial direction of the motor generator can also be absorbed to a certain degree.

As shown in FIG. 15, the tip portion of bus bar 263 may also be bent and allowed to extend in the axial direction of the motor generator and in a direction away from coil end 262. Onto the tip portion of bus bar 263, crimping terminal portion 40 of connecting member 4 is crimped. Misalignment absorbing portion 46 is provided between bent portion 41 and crimping terminal portion 40, and protrudes in a direction crossing the axial direction of the motor generator (a direction in which bus bar 263 is led out). Other configurations are basically similar to those shown in FIG. 14.

In the present modification as well, misalignment absorbing portion 46 is provided at the portion of connecting member 4 on the other end side, which portion extends in the axial direction of the motor generator, and hence it is possible to increase an amount of deformation of connecting member 4 in the axial direction of the motor generator. Therefore, the present modification is useful if an amount of misalignment of bus bar 263 in the axial direction of the motor generator is large.

Further, if slotted hole 44 extending in a longitudinal direction of fixed portion 42 (the up-and-down direction in FIG. 15) is provided in fixed portion 42, slotted hole 44 can absorb misalignment of bus bar 263 in a direction crossing the axial direction of the motor generator. Further, connecting member 4 of the present modification can also be deformed to a certain degree in a direction crossing the axial direction of the motor generator, and hence with deformation of connecting member 4, it is also possible to absorb misalignment of bus bar 263 to a certain degree in a direction crossing the axial direction of the motor generator.

As described above, the embodiments of the present invention have been described. It is also expected from the beginning that the configurations of the embodiments described above are combined as appropriate. Furthermore, it should be understood that the embodiments disclosed herein are illustrative and not limitative in all aspects. The scope of the present invention is shown by the scope of the claims, and is intended to include all modifications within the equivalent meaning and scope of the claims.

### INDUSTRIAL APPLICABILITY

The present invention can effectively be applied to a connecting structure for connecting an electrical apparatus and a feeder terminal portion, and a vehicle.

1. A connecting structure for connecting an electrical apparatus and a feeder terminal portion, comprising:
a led-out conductor portion led out from the electrical apparatus;
a feeder terminal portion disposed at a spacing from said led-out conductor portion at a position displaced from a tip portion of said led-out conductor portion in a direction in which said led-out conductor portion is led out, and having a feeder wire connected thereto; and
a connecting member connecting said led-out conductor portion and said feeder terminal portion, wherein
said connecting member includes
a first bent portion allowing the connecting member to have a bent shape as a whole, and
a misalignment absorbing portion which is provided by bending a part of said connecting member, includes a plurality of second bent portions, and is deformable to absorb misalignment between said led-out conductor portion and said feeder terminal portion.

2. The connecting structure for connecting the electrical apparatus and the feeder terminal portion according to claim 1, wherein
said electrical apparatus is a rotating electrical machine,
a coating layer is formed at a surface of said led-out conductor portion to improve stiffness of said led-out conductor portion, and said feeder terminal portion is a feeding terminal block.

3. The connecting structure for connecting the electrical apparatus and the feeder terminal portion according to claim 1, wherein
said connecting member further has a fixed portion fixed to said feeder terminal portion and a crimping terminal portion crimped onto said led-out conductor portion,
said fixed portion is provided on one end side of said connecting member,
said crimping terminal portion is provided on the other end side of said connecting member,
said first bent portion is provided between said fixed portion and said crimping terminal portion, and
said misalignment absorbing portion is provided between said first bent portion and said crimping terminal portion.

4. The connecting structure for connecting the electrical apparatus and the feeder terminal portion according to claim 1, wherein
said connecting member further has a fixed portion fixed to said feeder terminal portion and a crimping terminal portion crimped onto said led-out conductor portion,
said fixed portion is provided on one end side of said connecting member,
said crimping terminal portion is provided on the other end side of said connecting member,
said first bent portion is provided between said fixed portion and said crimping terminal portion, and
said misalignment absorbing portion is provided between said first bent portion and said fixed portion.

5. The connecting structure for connecting the electrical apparatus and the feeder terminal portion according to claim 3, wherein
a portion of said connecting member on said other end side extends in a direction crossing a portion of said connecting member on said one end side, which portion of said connecting member on said one end side includes said fixed portion,
said fixed portion is fixed to said feeder terminal portion with a fixing member, and has a slotted hole for receiving said fixing member, and
a longitudinal direction of said slotted hole is a direction identical to a direction in which the portion of said connecting member on said one end side extends.

6. The connecting structure for connecting the electrical apparatus and the feeder terminal portion according to claim 1, wherein said misalignment absorbing portion is provided at said connecting member in a convex manner by bending and deforming said connecting member at a plurality of sites.

7. The connecting structure for connecting the electrical apparatus and the feeder terminal portion according to claim 6, wherein
a portion of said connecting member on the other end side extends along the direction in which said led-out conductor portion is led out, and
said misalignment absorbing portion is provided at said connecting member such that said misalignment absorbing portion protrudes in a direction crossing the direction in which said led-out conductor portion is led out.

8. The connecting structure for connecting the electrical apparatus and the feeder terminal portion according to claim 6, wherein
a portion of said connecting member on the other end side extends along the direction in which said led-out conductor portion is led out, and
said misalignment absorbing portion is provided at said connecting member such that said misalignment absorbing portion protrudes in the direction in which said led-out conductor portion is led out.

9. The connecting structure for connecting the electrical apparatus and the feeder terminal portion according to claim 6, wherein
a portion of said connecting member on the other end side extends in a direction crossing the direction in which said led-out conductor portion is led out, and
said misalignment absorbing portion is provided at said connecting member such that said misalignment absorbing portion protrudes in a direction crossing the direction in which said led-out conductor portion is led out.

10. The connecting structure for connecting the electrical apparatus and the feeder terminal portion according to claim 6, wherein
a portion of said connecting member on the other end side extends in a direction crossing the direction in which said led-out conductor portion is led out, and
said misalignment absorbing portion is provided at said connecting member such that said misalignment absorbing portion protrudes in the direction in which said led-out conductor portion is led out.

11. The connecting structure for connecting the electrical apparatus and the feeder terminal portion according to claim 1, wherein said connecting member is configured with a single-piece plate-like metal member.

12. The connecting structure for connecting the electrical apparatus and the feeder terminal portion according to claim 1, wherein said misalignment absorbing portion has an approximately U-shape.

13. The connecting structure for connecting the electrical apparatus and the feeder terminal portion according to claim 1, wherein
said connecting member further has a fixed portion fixed to said feeder terminal portion and a crimping terminal portion crimped onto said led-out conductor portion,
said fixed portion is provided on one end side of said connecting member,
said crimping terminal portion is provided on the other end side of said connecting member,
said first bent portion is provided between said fixed portion and said crimping terminal portion, and
an intermediate portion of said connecting member, positioned between said first bent portion and one of said crimping terminal portion and said fixed portion, is configured with a combination of a plurality of circular arc-shaped portions each conforming to a circular arc having a radius R, and a length L of said intermediate portion is set to satisfy a relation of R=L/5.

14. The connecting structure for connecting the electrical apparatus and the feeder terminal portion according to claim 1, wherein
said misalignment absorbing portion is provided by bending and deforming said connecting member at a plurality of sites, and
a thickness of said second bent portions and their vicinity of said misalignment absorbing portion is made larger than a thickness of a portion of said misalignment absorbing portion other than the second bent portions and their vicinity.

15. A vehicle comprising the connecting structure for connecting the electrical apparatus and the feeder terminal portion, recited in claim 1.

16. The connecting structure for connecting the electrical apparatus and the feeder terminal portion according to claim 1, wherein
said connecting member has a portion on one end side, positioned between said first bent portion and one end portion of said connecting member, and a portion on the other end side, positioned between said first bent portion and the other end portion of said connecting member, and
one of the portion on said one end side and the portion on said other end side extends along said led-out conductor portion, and the other of the portion on said one end side and the portion on said other end side extends in a direction crossing a direction in which said led-out conductor portion extends.

17. The connecting structure for connecting the electrical apparatus and the feeder terminal portion according to claim 2, wherein the led-out conductor portion extends in an axial direction of said rotating electrical machine.

18. The connecting structure for connecting the electrical apparatus and the feeder terminal portion according to claim 2, wherein the led-out conductor portion includes a portion extending in a direction crossing an axial direction of said rotating electrical machine.
